(19) United States
(12) Patent Application Publication
(10) Pub. No.: US 2026/0278438 A1
(43) Pub. Date: Sep. 17, 2026

(54) QUANTUM TELEPORTATION DRIVEN SYSTEM CONFIGURATION

(71) Applicant: Red Hat, Inc., Raleigh, NC (US)

(72) Inventors: Leigh Griffin, Waterford (IE); Stephen Coady, Dublin (IE)

(21) Appl. No.: 18/988,019

(22) Filed: Dec. 19, 2024

(51) Int. Cl. G06N 10/40

(52) U.S. Cl. CPC G06N 10/40

(57) ABSTRACT

A system can: identify, by a first quantum computing device a state change of a quantum state of a first qubit at the first quantum computing device based on an occurrence of a quantum teleportation of quantum information to the first qubit; receive, by the first quantum computing device, classical information associated with the quantum teleportation; determine, by the first quantum computing device, a control action for the first quantum computing device based on the classical information and the quantum state of the first qubit subsequent to the state change; and implement, by the first quantum computing device, the control action to control the first quantum computing device.

### BACKGROUND

Quantum computing involves the use of quantum bits, referred to herein as “qubits,” which have characteristics that differ from those of classical (i.e., non-quantum) bits used in classical computing. For example, while a classical bit may be in a state of either one (1) or zero (0), a qubit may be in a “superposition” of both states simultaneously. A pair of qubits may also experience a physical phenomenon referred to as “entanglement,” in which the quantum state of each qubit cannot be described independently of the state of the other qubit.

### SUMMARY

Sending secure messages is a challenge in computing environments due to the chance of messages being intercepted by adverse parties. Providing secure messages can be especially important when making configuration or environmental changes to a system. Interception of the messages used to configure a system can present significant risks to security of the system. Although many classical approaches exist to reduce the risk of interception by an adverse party, such classical communications may require the communication of data over a classical communication channel (e.g., a network), which will introduce some risk of interception.

The present disclosure provides for the use of quantum teleportation as a secure approach for passing messages for configuring and/or updating systems. Quantum teleportation refers to a process whereby a set of two entangled qubits at two quantum computing devices are used to transport quantum information from a third qubit at one of the quantum computing devices to the entangled qubit at the other of the quantum computing devices. The proposed mechanism acts as a watcher on a quantum teleportation service that watches for incoming teleportation actions transferred via the teleportation service. The teleportation service creates or otherwise accesses a mapping of states that a teleported qubit may arrive in relative to control actions for controlling or modifying the second quantum computing device. The mapping may, for example, specify a type or parameter of the control action based on an attribute of the quantum state. In some implementations, classical information that is transmitted along with the quantum teleportation can further be used to inform the control action along with the teleported quantum state. For example, some portion of the control action can be defined based the mapping of teleported states to control actions, whereas another portion of the control action (e.g., a parameter) can be defined based on the classical information. Because it is presently unknown how information teleported by quantum teleportation can be intercepted, quantum teleporting information relating even a portion of the control action can significantly complicate, if not outright thwart, any attempts at intercepting the control action from an adverse party.

The present disclosure can provide that two quantum-enabled systems can securely communicate information for controlling the actions of the systems. Furthermore, this technique can be applied for updating secure information, including the mapping itself, such that configurations of a plurality of quantum computing devices can be securely updated (e.g., synchronized) without risk of breach due to the secure nature of quantum teleportation. For instance, a central quantum computing device can maintain entangled qubits with a plurality of distributed quantum computing devices. The central quantum computing device can provide for synchronizing the plurality of distributed quantum computing devices, even when those distributed quantum computing devices are isolated from the central quantum computing device over classical communication channels, by teleporting data over each entangled qubit. This can provide for a central system to securely and near-instantaneously synchronize quantum-enabled systems irrespective of the physical proximity between the central quantum computing device and the distributed systems.

In one implementation, a method is provided. The method includes identifying, by a first quantum computing device, a state change of a quantum state of a first qubit at the first quantum computing device based on an occurrence of a quantum teleportation of quantum information to the first qubit. The method further includes receiving, by the first quantum computing device, classical information associated with the quantum teleportation. The method further includes determining, by the first quantum computing device, a control action for the first quantum computing device based on the classical information and the quantum state of the first qubit subsequent to the state change. The method further includes implementing, by the first quantum computing device, the control action to control the first quantum computing device.

In another implementation, a quantum computing device is provided. The quantum computing device includes a memory, and a processor device coupled to the memory. The processor device is to identify a state change of a quantum state of a first qubit at the quantum computing device based on an occurrence of a quantum teleportation of quantum information to the first qubit. The processor device is further to receive, by the quantum computing device, classical information associated with the quantum teleportation. The processor device is further to determine, by the quantum computing device, a control action for the quantum computing device based on the classical information and the quantum state of the first qubit subsequent to the state change. The executable instructions further cause the processor device to implement, by the quantum computing device, the control action to control the quantum computing device.

In another implementation, a non-transitory computer-readable storage medium is provided. The non-transitory computer-readable storage medium includes executable instructions to cause a processor device of a quantum computing device to identify a state change of a quantum state of a first qubit at the quantum computing device based on an occurrence of a quantum teleportation of quantum information to the first qubit. The executable instructions further cause the processor device to receive, by the quantum computing device, classical information associated with the quantum teleportation. The executable instructions further cause the processor device to determine, by the quantum computing device, a control action for the quantum computing device based on the classical information and the quantum state of the first qubit subsequent to the state change. The executable instructions further cause the processor device to implement, by the quantum computing device, the control action to control the quantum computing device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a quantum system according to one implementation.

FIG. 2 is a flowchart of a method for quantum teleportation driven system configuration based on quantum resource availability according to one implementation.

FIG. 3 is a simplified diagram of a quantum computing device according to one implementation.

FIG. 4 is a block diagram of a computing device suitable for implementing examples according to one implementation.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

The present disclosure provides systems and methods for improved transfer of data to systems utilizing quantum teleportation. Quantum computing and quantum information processing involve the use of quantum bits, referred to herein as “qubits,” which have characteristics that differ from those of classical (i.e., non-quantum) bits used in classical computing. Qubits may be employed by quantum services that are executed by quantum computing devices. A qubit encodes quantum information for an underlying particle such as an atom or a photon, and possesses characteristics that differ from those of classical (i.e., non-quantum) bits used in classical computing. For example, while a classical bit may be in a state of either one (1) or zero (0), a qubit may be in a “superposition” of both states simultaneously.

A pair of qubits may also experience a physical phenomenon referred to as “entanglement,” in which the quantum state of each qubit cannot be described independently of the state of the other qubit. Using the phenomenon of entanglement, multiple qubits may be linked together in such a manner that performing a quantum action on a first qubit (e.g., measuring the quantum state of the first qubit) determines the possible quantum states of a second qubit that is in an entangled state with the first qubit.

Qubits may also be used to perform a process called quantum teleportation. Quantum teleportation is a technique for transferring quantum information from a sender to a receiver across great distances, even when the sender and receiver are physically isolated and/or communicatively isolated by classical networks. For example, quantum teleportation can be utilized to transmit quantum information even when the location of the receiver and/or the particular state being transferred is unknown. Two quantum computing devices can share a pair of entangled qubits, with a qubit to be teleported at one of the quantum computing devices. The qubit to be teleported can interact with one of the pair of entangled qubits to induce a state change at the other entangled qubit, creating a “teleported” qubit. This can be referred to as “receiving” the teleported qubit, although the qubits are not necessarily physically moved.

Based on the attributes of this state change, the quantum computing device can determine a control action to implement to modify the operation of the quantum computing device. For example, in some implementations, the quantum computing device can maintain or otherwise access a mapping of control actions to state data (and/or changes in state data). The mapping can define which of an ordered plurality of control actions for the quantum computing device to take based on attributes of the quantum state of the teleported qubit. For example, in one implementation, the mapping may define two control actions, where the mapping indicates a first control action if a given attribute (e.g., a spin) of the teleported qubit has a first value, and a second control action if the attribute (e.g., spin) of the teleported qubit has a second value. In some implementations, the mappings can be respective to multiple attributes and/or multiple teleported qubits to increase granularity of the control action selections. For example, a mapping may define a control action respective to a plurality of attributes of a plurality of teleported qubits. By utilizing a plurality of attributes and/or qubits, the system can decide between a sizable variety of control actions based on relatively little communicated information.

Furthermore, in some cases, classical information can accompany the quantum information due to the no-communication theorem of quantum physics. For instance, after the quantum information is teleported, classical information (e.g., a Bell state) is transmitted through a classical means of communication to preserve the quantum information in the qubit (e.g., by transmitting a change measurement between the teleporting qubit and the entangled qubit). This, for instance, can provide that the receiving quantum computing device can get the original information and reconstruct the teleported quantum information. This entanglement mechanism that provides for the transmission of quantum information with accompanying classical information can be referred to herein as a “quantum channel” or “quantum communication channel” (QCC). By including a third qubit that interacts with the entangled qubit at one side of the quantum communication channel to teleport quantum information to the entangled qubit at the other side of the quantum communication channel, the quantum communication channel can be augmented with quantum teleportation to facilitate the near-instantaneous transmission of quantum information.

According to the present disclosure, this property can be exploited to improve the capability of quantum computing systems as described herein. For instance, because the teleported qubit can be accompanied by classical information relating to the state change of the teleported qubit, the same mechanism used to communicate this information (e.g., a QCC) can further be used to communicate additional classical information. This classical information can therefore be utilized in determining the control action for the quantum computing device receiving the teleported qubit. For example, the classical information and the quantum information together can inform the entire control action, but individually each portion of information may inform only some portion of the control action. In this manner, even if an adverse party were to intercept the classical information, that party would not be able to determine the control action as some portion of the control action would be dependent on the quantum state of the teleported qubit.

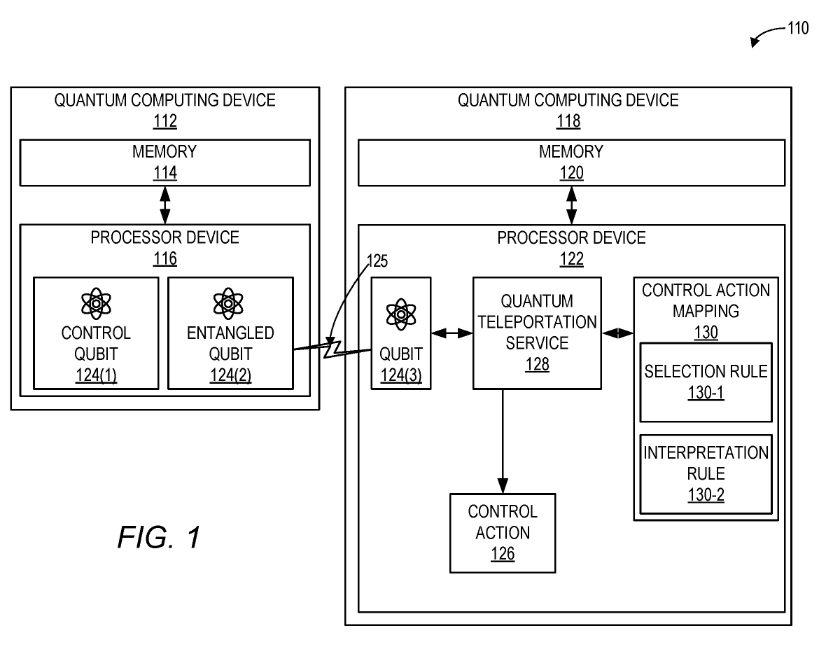

FIG. 1 is a block diagram of a quantum system 110 in which examples may be practiced. The quantum system 110 includes a quantum computing device 112 (i.e., the “first quantum computing device 112”) that comprises a first memory 114 and a first quantum processor device 116, and also includes a quantum computing device 118 (i.e., the “second quantum computing device 118”) that comprises a second memory 120 and a second processor device 122. It is to be understood that the quantum system 110 according to some examples may include other classical computing devices and/or additional quantum computing devices that are not illustrated in FIG. 11. Additionally, the first quantum computing device 112 and the second quantum computing device 118 in some examples may include constituent elements in addition to those illustrated in FIG. 11.

The first quantum processor device 116 and the second processor device 122 can each include one or more qubits (collectively referred to as qubits 124). For instance, the qubits 124 at the first quantum processor device 116 can include, but are not limited to, a control qubit 124(1) (e.g., a first qubit) and a first entangled qubit 124(2) (e.g., a second qubit). Additionally or alternatively, the qubits 124 at the second processor device 122 can include, but are not limited to, a second entangled qubit 124(3) (e.g., a third qubit). The first entangled qubit 124(2) and the second entangled qubit 124(3) can provide a quantum communication channel (QCC) 125 through their entanglement. The QCC 125 can provide for securely teleporting quantum information from the control qubit 124(1) of the first quantum computing device 112 to the second quantum computing device 118.

According to some examples, prior to the quantum system 110 performing the operations described in greater detail below, an entangled state is induced between the first entangled qubit 124(2) and the second entangled qubit 124(3), with the first entangled qubit 124(2) subsequently being sent to the first quantum computing device 112 and the second entangled qubit 124(3) being sent to the second quantum computing device 118. Inducing the entangled state between the first entangled qubit 124(2) and the second entangled qubit 124(3) may be performed, e.g., by a quantum computing device using Quantum Assembly (QASM) files to apply a Hadamard gate to the first entangled qubit 124(2) to place it a state of superposition, and then apply a CNOT gate to the second entangled qubit 124(3), as a non-limiting example. Qubits such as first entangled qubit 124(2) and the second entangled qubit 124(3) may be transferred among the first quantum computing device 112 and the second quantum computing device 118 in the form of photons transmitted via fiber optic cabling or through free space using pulsed lasers, as non-limiting examples.

According to example aspects of the present disclosure, quantum teleportation can be used to induce a control action 126 at the second quantum computing device 118 based on the quantum information teleported from the first quantum computing device 112. For instance, the first quantum computing device 112 can be a central device in communication with one or more distributed devices including the second quantum computing device 118. For example, in some implementations, a plurality of similar or identical quantum computing devices to the second quantum computing device 118 can be in communication with the first quantum computing device 112 over additional quantum communication channels. The first quantum computing device 112 can communicate quantum information as described herein to synchronize the second quantum computing device 118 and/or additional quantum computing devices.

The quantum computing device 118 can receive teleported quantum information by the second entangled qubit 124(3) and determine the control action 126 based on a state of the second entangled qubit 124(3) after the teleported quantum information is received. For instance, a quantum teleportation service 128 can monitor a state of the second entangled qubit 124(3). The quantum state of the second entangled qubit 124(3) observed by the quantum teleportation service 128 may include attributes such as but not limited to, a Bell state, a spin, a rotation angle, a degree, a plane, a polarity, a qubit type, a qubit identifier, a qubit group, a qubit material, or an energy level of second entangled qubit 124(3). As illustrated, some of the attributes used for determining the control action 126 may be associated with the second entangled qubit 124(3) itself, such as material type or qubit identifier.

The quantum teleportation service 128 can identify a state change of a quantum state of the second entangled qubit 124(3) at the second quantum computing device 118 based on an occurrence of a quantum teleportation of quantum information to the second entangled qubit 124(3). For instance, when the control qubit 124(1) interacts with the first entangled qubit 124(2) at the first quantum computing device 112, the entangled state between the first entangled qubit 124(2) and the second entangled qubit 124(3) can cause a state change at the second entangled qubit 124(3) that is related to the state change at the first entangled qubit 124(2) caused by interaction with the control qubit 124(1). For instance, in some implementations, identifying the state change can include instantiating the second entangled qubit 124(3) in a quantum entangled state with the first entangled qubit 124(2) at the first quantum computing device 112 and identifying the state change of the second entangled qubit 124(3) based on a change in the quantum entangled state of the first entangled qubit 124(2).

Additionally and/or alternatively, the quantum computing device 118 can receive (e.g., over the QCC 125) classical information associated with the quantum teleportation. The second quantum computing device 118 can determine the control action 126 based on the classical information and the quantum state of the second entangled qubit 124(3) subsequent to the state change. For instance, in some cases, the exact state of the second entangled qubit 124(3) after teleportation can be used to determine the control action 126. Additionally and/or alternatively, in some implementations, the original state of the first entangled qubit 124(2) can be reconstructed using the classical information prior to determining the control action 126.

The classical information can include a measurement result between the control qubit 124(1) and the first entangled qubit 124(2) for the purposes of preserving the quantum information and satisfying the no-communication theorem of quantum physics. Additionally or alternatively, the classical information transmitted over the QCC 125 can include other classical information relevant for informing the control action 126. The classical information can be interpreted in accordance with the quantum state of the second entangled qubit 124(3). For instance, a control action mapping 130 can define relationships or rules indicating portions or commands in the control action 126 based on the quantum state of the second entangled qubit 124(3).

As one example, the classical information can include an ordered plurality of control actions comprising the control action 126. The quantum state can inform which of the ordered plurality of control actions to select as the control action 126. For instance, the second quantum computing device 118 can select the control action 126 from the ordered plurality of control actions of the classical information. Selecting the control action 126 from the ordered plurality of control actions can include accessing a selection rule 130-1 (e.g., of the control action mapping 130) that defines a relationship between an attribute of the quantum state of the second entangled qubit 124(3) and a position within the ordered plurality of control actions to be selected as the control action 126 and selecting the control action 126 based on the position within the ordered plurality of control actions. As one example for the purposes of illustration, the ordered plurality of control actions may include two possible control actions, and the selection rule 130-1 may instruct the second quantum computing device 118 to implement the first control action if the spin of the qubit 124(3) is in a first direction and to implement the second control action if the spin is in a second direction.

As another example, the control action 126 can have a type and a parameter. The type of the control action 126 can specify which operation(s) is/are to be performed when the control action 126 is implemented. As examples, a type of control action 126 may include content update, operating temperature configuration, qubit configuration, qubit measurement, rule update, or other type of control action 126. The parameter of the control action 126 can specify a value for the operation to be implemented. For example, if the type is operating temperature configuration, the parameter can specify what operating temperature to configure the second quantum computing device 118 at. More particularly, in some implementations, determining the control action 126 can include determining a parameter of the control action 126 based on the classical information and determining a type of the control action 126 based on the quantum state of the second entangled qubit 124(3). For example, in some implementations, the attributes of the quantum state can inform which of a list of operations to perform, while the classical information can specify values for the selected operation.

As another example, in some implementations, determining the parameter of the control action can include accessing an interpretation rule 130-2 that defines a relationship between the classical information transmitted via the QCC 125 and a value of the parameter of the control action 126 and determining the parameter of the control action 126 based on the interpretation rule 130-2. Additionally or alternatively, in some implementations, the parameter may be determined based on the quantum state and the type can be determined based on the classical information.

The second quantum computing device 118 can be controlled based on the control action 126. For instance, in some implementations, the second quantum computing device 118 can be synchronized with the first quantum computing device 112 based on the control action 126. The control action 126 can be any suitable action for controlling the second quantum computing device 118. As non-limiting examples, the control action 126 can be implemented to control one or more of: an error correction algorithm, a configuration parameter, or an operating parameter of the second quantum computing device 118.

As another example, the control action 126 can include an update for the second quantum computing device 118. For instance, the control action 126 can instruct the second quantum computing device 118 to update content. For instance, in some examples, the classical information can be or can include content or update for a content. Additionally and/or alternatively, the quantum information can inform interpretation of the content or update for content (e.g., a file format for interpreting the classical information, an address for overwriting with the classical information, etc.). The content may include but is not necessarily limited to executable applications and operating systems (OS). The updates may be in the form of a patch update and/or patch upgrade. The update may be a security patch. In some implementations, to reduce the required bandwidth to transmit the patch update, and to reduce security concerns, the patch update may be transmitted via the QCC 125. The transmission of qubits, rather than classical bits, is inherently more secure and ensures the privacy of the transmitted data.

Furthermore, in some implementations, the control action 126 can even include updating the control action mapping 130 that was used to select the control action 126. For instance, in some implementations, the control action can include updating one of a plurality of selection rules comprising the selection rule 130-1. As another example, the control action 126 can include updating one of a plurality of interpretation rules comprising the interpretation rule 130-2. In this manner, the second quantum computing device 118 can be updated with new rules in the control action mapping 130 without risking exposing those rules to adverse parties. As one example, the second quantum computing device 118 may initially be configured with a “bare” set of control action mappings 130 that does not expose information about its functionality, such as a set including only control actions for adding new control action mapping rules. Once the second quantum computing device 118 is initialized, the first quantum computing device 112 can teleport information to cause the second quantum computing device 118 to populate its control action mapping 130 with control actions for desired functionality. In this manner, the second quantum computing device 118 can provide improved confidentiality guarantees of proprietary functionality.

By utilizing quantum teleportation as described herein, the devices can be synchronized regardless of where in space the devices are positioned and/or the classical communication capabilities of the devices. For instance, in some implementations, the first quantum computing device 112 may be isolated from the second quantum computing device 118 by classical communication means, such as networks, internet, ethernet, and so on such that the quantum communication channel 125 is the only means of communicating information between the devices.

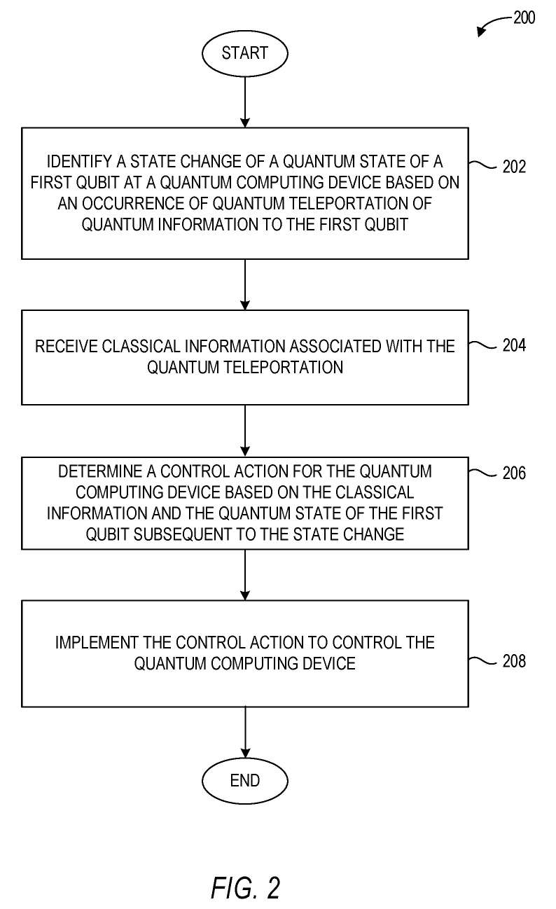

FIG. 2 is a flowchart of a method 200 for quantum teleportation driven system configuration based on quantum resource availability according to one implementation. At 202, the method 200 includes identifying a state change of a quantum state of a qubit 124 at the quantum computing device 118 based on an occurrence of a quantum teleportation of quantum information to the qubit 124. At 204, the method 200 includes receiving, by the quantum computing device 118, classical information associated with the quantum teleportation. At 206, the method 200 includes determining a control action 126 for the quantum computing device 118 based on the classical information and the quantum state of the qubit 124 subsequent to the state change. At 208, the method 200 includes implementing the control action 126 to control the quantum computing device 118.

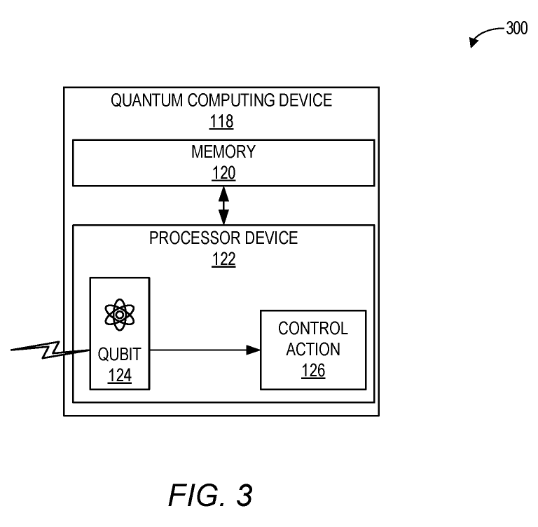

FIG. 3 is a block diagram of a computing system 300 according to one example. The computing system 300 includes a quantum computing device 118 having a memory 120 and a processor device 122 coupled to the memory 120. The processor device 122 is to identify a state change of a quantum state of a qubit 124 at the quantum computing device 118 based on an occurrence of a quantum teleportation of quantum information to the qubit 124. The processor device 122 is to receive, by the quantum computing device 118, classical information associated with the quantum teleportation. The processor device 122 is to determine a control action 126 for the quantum computing device 118 based on the classical information and the quantum state of the qubit 124 subsequent to the state change. The processor device 122 is to implement the control action 126 to control the quantum computing device 118.

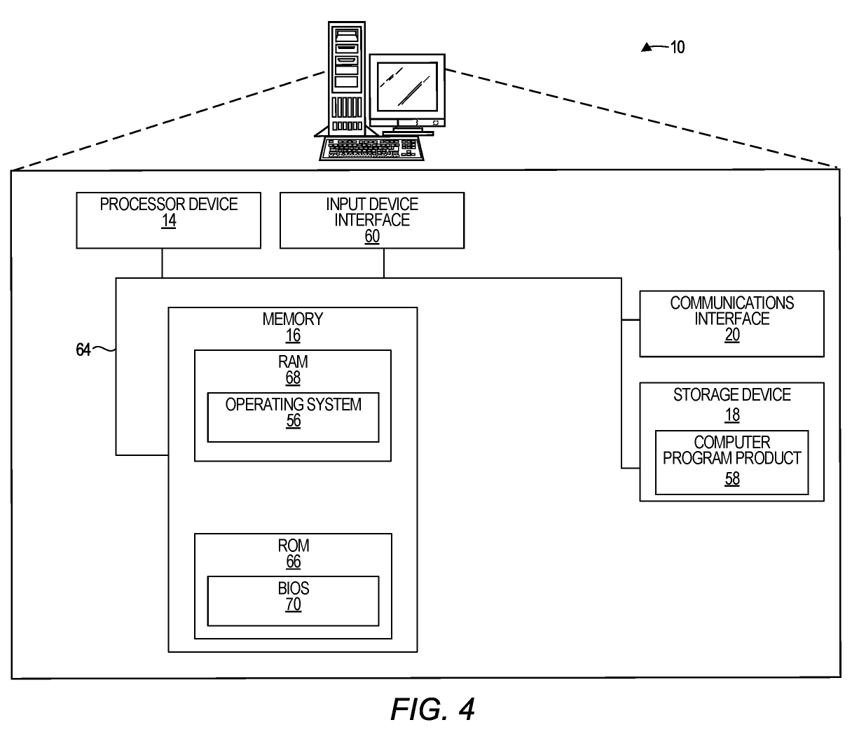

FIG. 4 is a block diagram of a computing device 10 suitable for implementing systems and methods according to one example. The computing device 10 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 10 includes a processor device 14, a system memory 16, and a system bus 64. The system bus 64 provides an interface for system components including, but not limited to, the system memory 16 and the processor device 14. The processor device 14 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The system memory 16 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the computing device 10. The volatile memory 68 may also include a high-speed RAM, such as static RAM, for caching data.

The computing device 10 may further include or be coupled to a non-transitory computer-readable storage medium such as a storage device 18, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 18 and other drives associated with computer-readable media and computer-usable media may provide non-volatile storage of data, data structures, computer-executable instructions, and the like.

A number of modules can be stored in the storage device 18 and in the volatile memory 68, including an operating system and one or more program modules which may implement the functionality described herein in whole or in part. All or a portion of the examples may be implemented as a computer program product 58 stored on a transitory or non-transitory computer-usable or computer-readable storage medium, such as the storage device 18, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the computer program product 58 in the volatile memory 68, may serve as a controller, or control system, for the computing device 10 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 14 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The computing device 10 may also include a communications interface 20, such as an Ethernet transceiver and/or a Wi-Fi transceiver, or the like, suitable for communicating with a network as appropriate or desired. The computing device 10 may also include a video port configured to interface with a display device to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
identifying, by a first quantum computing device, a state change of a quantum state of a first qubit at the first quantum computing device based on an occurrence of a quantum teleportation of quantum information to the first qubit;
receiving, by the first quantum computing device, classical information associated with the quantum teleportation;
determining, by the first quantum computing device, a control action for the first quantum computing device based on the classical information and the quantum state of the first qubit subsequent to the state change; and
implementing, by the first quantum computing device, the control action to control the first quantum computing device.

2. The method of claim 1, wherein identifying the state change comprises instantiating the first qubit in a quantum entangled state with a second qubit at a second quantum computing device; and
identifying the state change of the quantum state of the first qubit based on a change in the quantum entangled state of the second qubit.

3. The method of claim 2, wherein the first quantum computing device is synchronized with the second quantum computing device based on the control action.

4. The method of claim 2, wherein the first quantum computing device and the second quantum computing device are coupled by a quantum communication channel (QCC); and
wherein the first qubit and the classical information are transmitted over the QCC.

5. The method of claim 1, wherein the classical information comprises an ordered plurality of control actions comprising the control action; and
wherein determining the control action comprises selecting the control action from the ordered plurality of control actions based on the quantum state of the first qubit.

6. The method of claim 5, wherein selecting the control action from the ordered plurality of control actions comprises:
accessing a selection rule defining a relationship between an attribute of the quantum state of the first qubit and a position within the ordered plurality of control actions to be selected; and
selecting the control action based on the position within the ordered plurality of control actions.

7. The method of claim 6, wherein the control action comprises updating one of a plurality of selection rules comprising the selection rule.

8. The method of claim 6, wherein the attribute comprises one of spin, angle, polarity, qubit type, qubit identifier, qubit group, qubit material, or energy level.

9. The method of claim 1, wherein determining the control action comprises:
determining a parameter of the control action based on the classical information; and
determining a type of the control action based on the quantum state of the first qubit.

10. The method of claim 9, wherein determining the parameter of the control action comprises:
accessing an interpretation rule, the interpretation rule defining a relationship between the classical information and a value of the parameter of the control action; and
determining the parameter of the control action based on the interpretation rule.

11. The method of claim 10, wherein the control action comprises updating one of a plurality of interpretation rules comprising the interpretation rule.

12. The method of claim 1, wherein the control action is implemented to control one or more of: an error correction algorithm, a configuration parameter, or an operating parameter of the first quantum computing device.

13. The method of claim 1, wherein the control action comprises an update for the first quantum computing device.

14. A quantum computing device, comprising:
a memory; and
a processor device coupled to the memory to:
identify a state change of a quantum state of a first qubit at the quantum computing device based on an occurrence of a quantum teleportation of quantum information to the first qubit;
receive classical information associated with the quantum teleportation;
determine a control action for the quantum computing device based on the classical information and the quantum state of the first qubit subsequent to the state change; and
implement the control action to control the quantum computing device.

15. The computing system of claim 14, wherein the quantum computing device comprises a first quantum computing device; and
wherein, to identify the state change, the processor device is to:
instantiate the first qubit in a quantum entangled state with a second qubit at a second quantum computing device; and
identify the state change of the quantum state of the first qubit based on a change in the quantum entangled state of the second qubit.

16. The computing system of claim 15, wherein the first quantum computing device and the second quantum computing device are coupled by a quantum communication channel (QCC); and
wherein the second quantum computing device is further to teleport the first qubit and transmit the classical information over the QCC.

17. The computing system of claim 14, wherein the classical information comprises an ordered plurality of control actions comprising the control action; and
wherein, to determine the control action, the processor device is to select the control action from the ordered plurality of control actions based on the quantum state of the first qubit.

18. The computing system of claim 17, wherein, to select the control action from the ordered plurality of control actions, the processor device is to:
access a selection rule defining a relationship between an attribute of the quantum state of the first qubit and a position within the ordered plurality of control actions to be selected; and
select the control action based on the position within the ordered plurality of control actions.

19. The computing system of claim 14, wherein, to determine the control action, the processor device is to
determine a parameter of the control action based on the classical information; and
determine a type of the control action based on the quantum state of the first qubit.

20. A non-transitory computer-readable storage medium that includes executable instructions to cause a processor device of a quantum computing device to:
identify a state change of a quantum state of a first qubit at the quantum computing device based on an occurrence of a quantum teleportation of quantum information to the first qubit;
receive classical information associated with the quantum teleportation;
determine a control action for the quantum computing device based on the classical information and the quantum state of the first qubit subsequent to the state change; and
implement the control action to control the first quantum computing device.
